(19) United States
(12) Patent Application Publication
(10) Pub. No.: US 2009/0156343 A1
(43) Pub. Date: Jun. 18, 2009

(54) Force multiplying control cable system

(76) Inventor: Mark W. Stevenson, Appleton, NY (US)

Correspondence Address: DELPHI TECHNOLOGIES, INC., M/C 480-410-202, PO BOX 5052, TROY, MI, 48007, US

(21) Appl. No.: 12/002,066

(22) Filed: Dec. 14, 2007

(51) Int. Cl. F16H 7/04

(52) U.S. Cl. 474/167

(57) ABSTRACT

A control system for use in an HVAC unit comprises a circular pulley, a semi-circular pulley, and a cable interconnecting the pulleys to rotate a spur gear. A flange extends about the periphery of the semi-circular pulley and pulley gear teeth extend radially inwardly from the flange and engage the spur gear teeth. The spur gear is rotatably supported on a gear shaft which extends through a slot in the semi-circular pulley that extends arcuately between two slot ends. The slot is spaced radially between the flange and a support shaft of the semi-circular pulley thereby allowing the semi-circular pulley and the spur gear to overlap to attain compact packaging of the system.

### BACKGROUND OF THE INVENTION

1. Field of the Invention

The present invention relates to a control system for use in a heating and ventilation and air conditioning (HVAC) unit.

2. Description of the Prior Art

Common devices used to manually control temperature in the HVAC unit are often comprised of pulleys connected to one another with small diameter cables. The size requirements of these pulley devices often leads to an inability to generate enough torque to easily overcome the resisting force of the HVAC unit. This creates force limitations within the HVAC unit which need to be considered during the design process. Current cable devices utilize single larger output pulleys, lever arm extensions, and complex gear boxes to achieve an increase in force with low input effort.

One such device comprises a first housing, a circular pulley having a circular pulley radius defining a circumference rotatably mounted to the first housing on a first axis, and a rotary control knob attached to the circular pulley for rotating the circular pulley to select a temperature. The device includes a second housing and a semi-circular pulley rotatably mounted to the second housing on the second axis for rotation between two stop positions. The semi-circular pulley has a base plate having a semi-circular pulley radius defining a semi-circular periphery extending about the second axis.

A cable connects the circular pulley to the semi-circular pulley to rotate the semi-circular pulley in response to the rotation of the circular pulley. A spur gear having a center and a spur gear radius defining a spur gear circumference is also rotatably mounted to the second housing. Spur gear teeth are disposed about the spur gear circumference and extend radially outwardly whereby the dimensions of the entire package must include the stacked widths of the circular pulley and the spur gear.

### SUMMARY OF THE INVENTION AND ADVANTAGES

The invention provides such a control system wherein the semi-circular periphery of the semi-circular pulley includes a flange that extends axially from the base plate and about the periphery between two diametrically opposite flange ends on a diameter. The semi-circular pulley has pulley gear teeth disposed about the semi-circular periphery that extend radially inwardly from the flange and engage with the spur gear teeth of the spur gear to drive the spur gear.

In this disposition, the spur gear can be disposed within the periphery of the semi-circular pulley thereby providing compact packaging while also providing a mechanical advantage to increase the force with which the spur gear rotates. In other words, the dimensions of the entire package are determined by the width of the overlapping semi-circular pulley and the spur gear, i.e., the width of the semi-circular pulley alone.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the invention;

FIG. 2 is a perspective view of the circular pulley with a portion of the first housing removed therefrom;

FIG. 3 is a top view of the semi-circular pulley with a portion of the second housing removed therefrom;

FIG. 4 is a top view of the spur gear and the semi-circular pulley in one of two stop positions;

FIG. 5 is a top view of the spur gear and the semi-circular pulley in the other of two stop positions; and

FIG. 6 is a perspective view of the second housing, the semi-circular pulley, the spur gear, a drive gear, and a blend door.

### DETAILED DESCRIPTION OF THE INVENTION

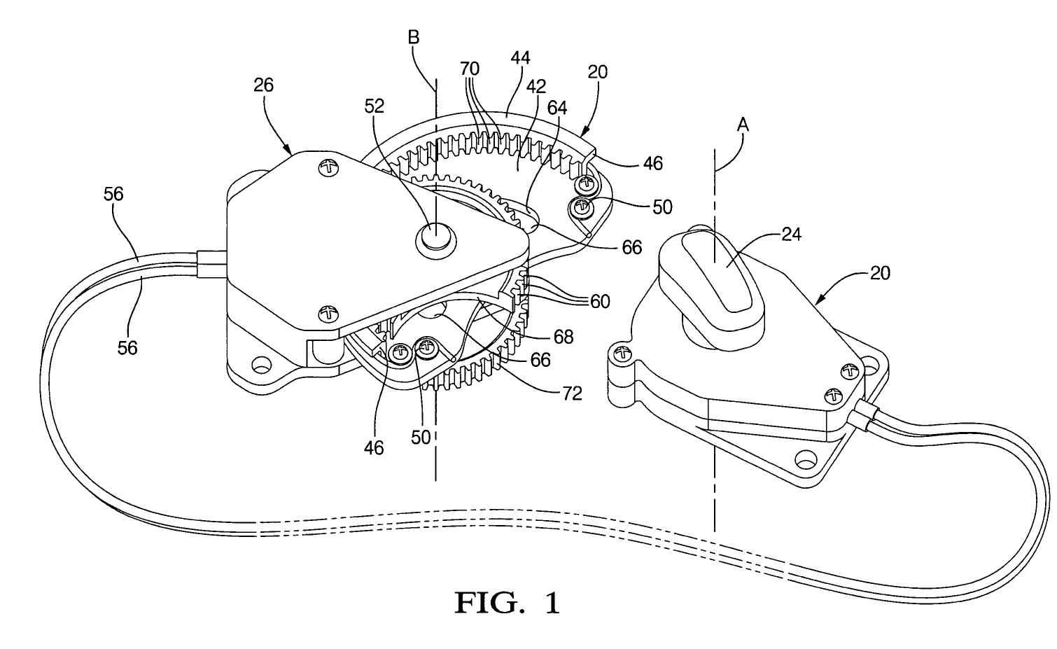

Referring to the Figures, a control system for use in a heating, ventilation, and air conditioning (HVAC) unit is shown in FIG. 1. The system comprises a first housing 20 rotatably supporting a first or circular pulley 22, which is rotated by a rotary control knob 24, a second housing 26 which rotatably supports a second or semi-circular pulley 28, and a cable 30 that interconnects the pulleys 22, 28 to rotate a spur gear 32.

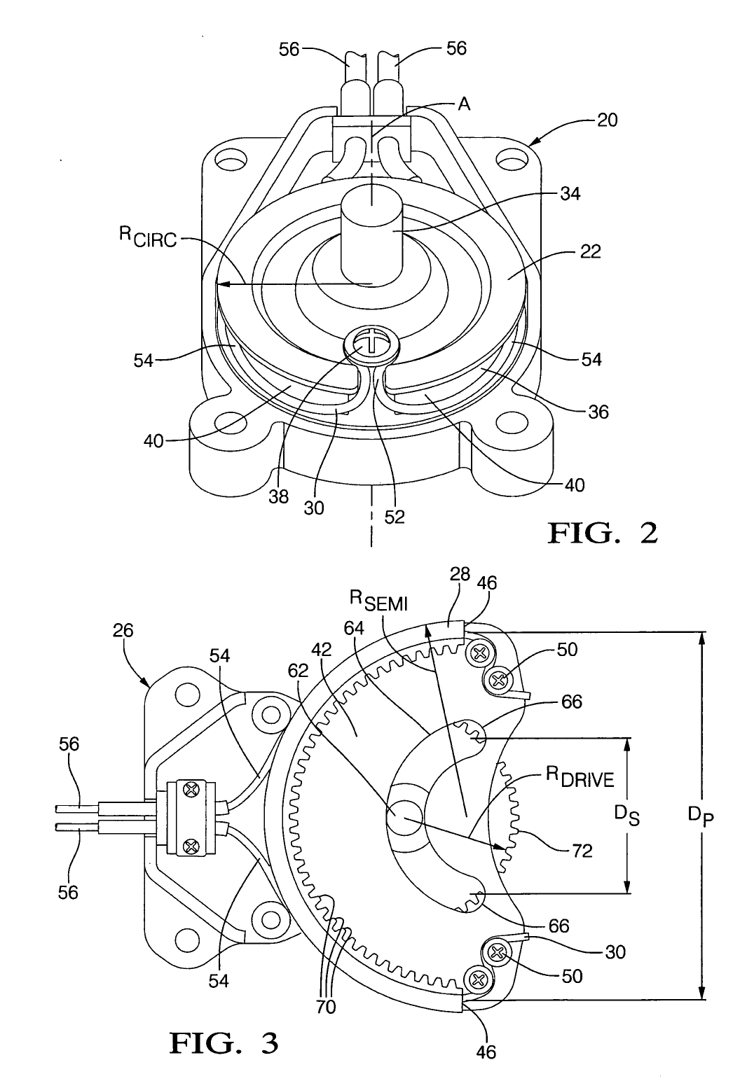

As shown in FIG. 2, the first housing 20 encloses and rotatably supports the circular pulley 22. The circular pulley 22 is rotatably mounted to the first housing 20 and has a pulley shaft 34 extending through the first housing 20 on a first axis A. The pulley shaft 34, and, consequently, the circular pulley 22, rotate around the first axis A. The rotary control knob 24 is attached to the pulley shaft 34 for rotating the circular pulley 22. As a passenger rotates the control knob to select a temperature, both the pulley shaft 34 and the circular pulley 22 rotate along with the control knob, i.e., there is a 1:1 relationship between the rotation of the rotary control knob 24 and the circular pulley 22.

The circular pulley 22 has a circular pulley radius Rcirc and a circumference. The circular pulley 22 defines a circular channel 36 that extends around the circumference from a connection point 38 thereby dividing the circular channel 36 circumferentially into two semi-circular sectors 40 extending in opposite directions from the connection point 38.

As shown in FIG. 3, the second housing 26 partially encloses the semi-circular pulley 28. The semi-circular pulley 28 is rotatably mounted to the second housing 26 on a second axis B. The semi-circular pulley 28 rotates around the second axis B between two stop positions.

The semi-circular pulley 28 includes a base plate 42 and a flange 44. The base plate 42 has a semi-circular pulley radius Rsemi defining a semi-circular periphery extending about an integral support shaft 45 on the second axis B. The flange 44 extends axially from the base plate 42 and about the periphery between two diametrically opposite flange ends 46 on a diameter D. The semi-circular pulley 28 defines a semi-circular channel 48 in the flange 44. The semi-circular channel 48 extends about the semi-circular periphery between the flange ends 46. An attachment point 50 extends axially from the base plate 42 radially inwardly from each of the flange ends 46 and on the opposite side of the diameter D from the flange 44. In other words, the base plate 42 includes two attachment points 50 adjacent the opposite flange ends 46 and adjacent the diameter D.

The cable 30 connects the circular pulley 22 to the semi-circular pulley 28 to transmit motion and rotate the semi-circular pulley 28 in response to the rotation of the circular pulley 22. The cable 30 has a midpoint 52 that is attached to the circular pulley 22 at the connection point 38. The cable 30 is entrained in the circular channel 36 about the semi-circular sectors 40 of the circular pulley 22. The cable 30 has two reaches 54 that extend from the circular pulley 22 and around opposite quadrants of the semi-circular channel 48. Each cable 30 is attached to a respective one of the attachment points 50 on the base plate 42 of the semi-circular pulley 28. In summary, as the circular pulley 22 is rotated via the rotary control knob 24, the cable 30 transmits the rotational movement from the circular pulley 22 to the semi-circular pulley 28 via rectilinear movement of the cable 30 along the reaches 54 between the pulleys 22, 28.

Each of a pair of tubes 56 is cylindrical in shape and disposed around one of the reaches 54 of the cable 30 between the circular pulley 22 and the semi-circular pulley 28. Each tube 56 guides and shields the respective reach 54 of the cable 30. The tubes 56 also prevent the respective reach 54 from kinking and/or from being damaged by the surrounding HVAC componentry.

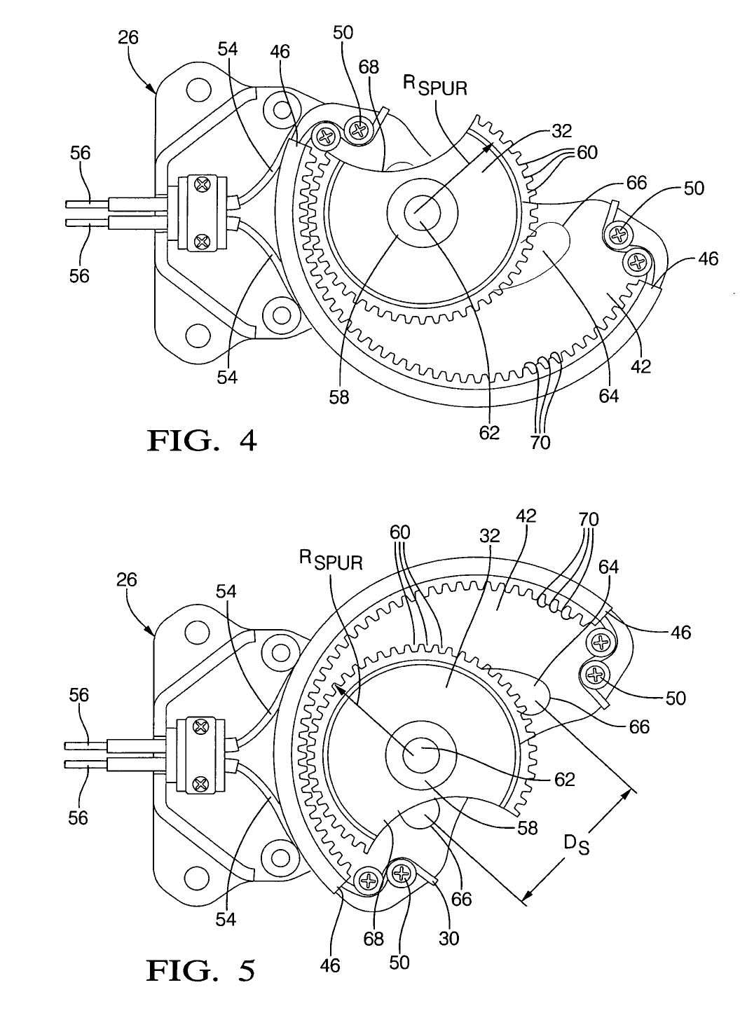

As shown in FIG. 4, the spur gear 32 has a spur gear radius Rspur to define a spur circumference about a center 58 and is rotatably mounted to the second housing 26 at the center 58. The spur gear 32 has spur gear teeth 60 disposed about the circumference and extending radially outwardly. A gear shaft 62 interconnects the center 58 of the spur gear 32 and the second housing 26 for rotatably supporting the spur gear 32 on the second housing 26 as the gear shaft 62 rotates along with the spur gear 32.

The center 58 of the spur gear 32 is disposed radially between the flange 44 and the second axis B of the semi-circular pulley 28. The base plate 42 defines a slot 64 that extends arcuately between slot ends 66 disposed on the diameter D. The slot 64 extends concentric with and spaced from the second axis B of the spur gear 32. The gear shaft 62 extends through the slot 64 for allowing the semi-circular pulley 28 to rotate about the second axis B as the slot 64 moves along the gear shaft 62 between the stop positions. The gear shaft 62 can engage the slot ends 66 at the stop positions, one of which is shown in FIG. 4 and the other of which is shown in FIG. 5.

The spur gear 32 defines a cutout sector 68. The attachment points 50 are disposed within the spur gear 32 circumference and within the cutout sector 68 of the spur gear 32 in each of the stop positions. Because of the cutout sector 68, the attachment points 50 can be disposed within the circular periphery of the spur gear 32 for compact packaging while attaining maximum mechanical advantage.

The pulley gear teeth 70 extend radially inwardly from the flange 44 of the semi-circular pulley 28 and engage with the spur gear teeth 60 of the spur gear 32, whereby the semi-circular pulley 28 drives the spur gear 32.

The circular pulley radius Rcirc is equal to the spur gear radius Rspur. The semi-circular pulley radius Rsemi is greater than the circular pulley radius Rcirc (as well as the spur gear radius Rspur). As such, the semi-circular pulley 28 rotates fewer degrees than the circular pulley 22 rotates when the circular pulley 22 is rotated via the rotary control knob 24. Because of the positioning of the spur gear 32 radially inwardly of the flange 44 and the difference between the semi-circular pulley radius Rsemi and the spur gear radius Rspur, the semi-circular pulley 28 and the pulley gear teeth 70 thereof drive the spur gear 32 and rotate the spur gear 32 more degrees than the rotation of the semi-circular pulley 28. In doing so, the semi-circular pulley 28 and the spur gear 32 create a mechanical advantage. As a result, the spur gear 32 is rotated with increased force while maintaining a rotation equal to that of the circular pulley 22. In other words, the circular pulley 22 and the spur gear 32 rotate at the same rate, however, the spur gear 32 rotates with increased force due to the mechanical advantage.

In a preferred embodiment, the semi-circular pulley radius Rsemi is four thirds greater than the circular pulley radius Rcirc. As the rotary control knob 24 is rotated 270° by the passenger, the circular pulley 22 will also rotate 270°. Accordingly, the semi-circular pulley 28 would rotate two thirds of the rotation of the circular pulley 22, i.e., 180°. The spur gear 32 would then rotate three halves of the rotation of the semi-circular pulley 28, i.e., 270°, in response to the rotation of the circular pulley 22 thereby increasing the force generated by the rotation of the circular pulley 22 and maintaining the rotation of the spur gear 32, i.e., 270°, equal to the rotation of the circular pulley 22, i.e., 270°.

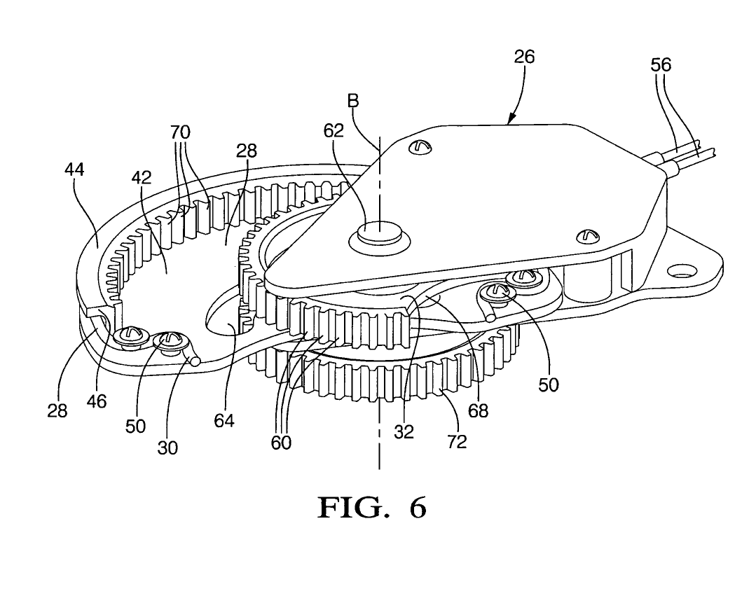

As shown in FIG. 6, a drive gear 72 having a circular circumference and a drive gear radius Rdrive equal to the spur gear radius Rspur can be connected to the gear shaft 62 and disposed beneath the base plate 42 for rotating with the spur gear 32. The drive gear 72 can be utilized to drive or rotate a device for controlling the flow of a stream of air produced by the HVAC unit. As an example, the device can be a blend door 74.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A control system for use in a heating and ventilation and air conditioning (HVAC) unit comprising;
a first housing,
a circular pulley rotatably mounted to said first housing on a first axis and having a circular pulley radius defining a circumference,
a rotary control knob attached to said circular pulley for rotating said circular pulley to select a temperature,
a second housing,
a semi-circular pulley rotatably mounted to said second housing on said second axis for rotation between stop positions,
said semi-circular pulley including a base plate having a semi-circular pulley radius defining a semi-circular periphery extending about a second axis,
a cable connecting said circular pulley to said semi-circular pulley to rotate said semi-circular pulley in response to the rotation of said circular pulley,
a spur gear rotatably mounted to said second housing and having a center and a spur gear radius defining a spur gear circumference and spur gear teeth disposed about said spur gear circumference and extending radially outwardly,
said semi-circular periphery including a flange extending axially from said base plate and about said periphery between two diametrically opposite flange ends on a diameter, and
said semi-circular pulley having pulley gear teeth disposed about said semi-circular periphery and extending radially inwardly from said flange and engaging with said spur gear teeth of said spur gear for driving said spur gear.

2. A system as set forth in claim 1 wherein said semi-circular pulley radius is greater than said circular pulley radius and said circular pulley radius is equal to said spur gear radius for driving said spur gear and rotating said spur gear more than the rotation of said semi-circular pulley in response to the rotation of said circular pulley thereby creating a mechanical advantage and increasing the force generated by the rotation of said circular pulley and maintaining the rotation of said spur gear equal to the rotation of said circular pulley.

3. A system as set forth in claim 1 wherein said center of said spur gear is disposed radially between said flange and said second axis of said semi-circular pulley.

4. A system as set forth in claim 3 wherein said base plate defines a slot extending arcuately between slot ends on said diameter and concentric with and spaced from said second axis.

5. A system as set forth in claim 4 including a gear shaft interconnecting said center of said spur gear and said second housing for rotatably supporting said spur gear on said second housing with said gear shaft extending through said slot for allowing said semi-circular pulley to rotate about said second axis as said slot moves along said gear shaft between said stop positions with said gear shaft engaging said slot ends at said stop positions.

6. A system as set forth in claim 5 wherein said gear shaft is connected to said spur gear for rotating therewith.

7. A system as set forth in claim 1 wherein said spur gear defines a cutout sector.

8. A system as set forth in claim 7 including an attachment point extending axially from said base plate radially inwardly from each of said flange ends and on the opposite side of said diameter from said flange.

9. A system as set forth in claim 8 wherein said attachment points are disposed within said spur gear circumference and said cutout sector of said spur gear in each of said stop positions.

10. A system as set forth in claim 9 wherein said circular pulley radius is equal to said spur gear radius.

11. A system as set forth in claim 10 wherein said semi-circular pulley radius is four thirds greater than said circular pulley radius for rotating said semi-circular pulley two thirds of the rotation of said circular pulley thereby driving said spur gear and rotating said spur gear three halves of the rotation of said semi-circular pulley thereby creating a mechanical advantage and increasing the force generated by the rotation of said circular pulley and maintaining the rotation of said spur gear equal to the rotation of said circular pulley.

12. A system as set forth in claim 11 including a drive gear having a circular circumference and a drive gear radius equal to said spur gear radius connected to said gear shaft and disposed beneath said base plate for rotating with said spur gear.

13. A system as set forth in claim 12 including a blend door driven by said drive gear for controlling the flow of a stream of air produced by the HVAC unit.

14. A system as set forth in claim 13 wherein said circular pulley has a pulley shaft extending through said first housing on said first axis.

15. A system as set forth in claim 14 wherein said rotary control knob is attached to said pulley shaft for rotating said circular pulley to select a temperature.

16. A system as set forth in claim 15 wherein said circular pulley defines a circular channel around said circumference from a connection point dividing said circular channel circumferentially into two semi-circular sectors extending in opposite directions from said connection point.

17. A system as set forth in claim 16 wherein said semi-circular pulley defines a semi-circular channel in said flange and extending about said semi-circular periphery between said flange ends.

18. A system as set forth in claim 17 wherein said cable has a midpoint attached to said circular pulley at said connection point and entrained in said circular channel about said semi-circular sectors of said circular pulley.

19. A system as set forth in claim 18 wherein said cable has two reaches extending from said circular pulley and around opposite quadrants of said semi-circular channel with each cable attached to a respective one of said attachment points on said base plate of said semi-circular pulley.

20. A system as set forth in claim 19 including a pair of tubes each being cylindrical in shape and disposed around one of said reaches of said cable between said circular pulley and said semi-circular pulley for guiding and shielding said reaches of said cable.

21. A control system for use in a heating and ventilation and air conditioning (HVAC) unit comprising;
a first housing,
a circular pulley rotatably mounted to said first housing and having a pulley shaft extending through said first housing on a first axis,
a rotary control knob attached to said pulley shaft for rotating said circular pulley to select a temperature,
said circular pulley having a circular pulley radius and a circumference extending in a circle and defining a circular channel around said circumference from a connection point dividing said circular channel circumferentially into two semi-circular sectors extending in opposite directions from said connection point,
a second housing,
a semi-circular pulley including a base plate having a semi-circular pulley radius defining a semi-circular periphery extending about an integral support shaft on a second axis and a flange extending axially from said base plate and about said periphery between two diametrically opposite flange ends on a diameter,
said semi-circular pulley defining a semi-circular channel in said flange and extending about said semi-circular periphery between said flange ends,
an attachment point extending axially from said base plate radially inwardly from each of said flange ends and on the opposite side of said diameter from said flange,
said semi-circular pulley being rotatably mounted to said second housing on said second axis for rotation between stop positions,
a cable connecting said circular pulley to said semi-circular pulley to rotate said semi-circular pulley in response to the rotation of said circular pulley,
said cable having a midpoint attached to said circular pulley at said connection point and entrained in said circular channel about said semi-circular sectors of said circular pulley,
said cable having two reaches extending from said circular pulley and around opposite quadrants of said semi-circular channel with each cable attached to a respective one of said attachment points on said base plate of said semi-circular pulley,
a pair of tubes each being cylindrical in shape and disposed around one of said reaches of said cable between said circular pulley and said semi-circular pulley for guiding and shielding said reaches of said cable,
a spur gear having a spur gear circumference and a center and a spur gear radius and rotatably mounted at said center to said second housing,
said spur gear having spur gear teeth disposed about said circumference and extending radially outwardly,
a gear shaft interconnecting said center of said spur gear and said second housing for rotatably supporting said spur gear on said second housing,
said gear shaft connected to said spur gear for rotation therewith,
a drive gear having a circular circumference and a drive gear radius equal to said spur gear radius connected to said gear shaft and disposed beneath said base plate for rotating with said spur gear,
a blend door driven by said drive gear for controlling the flow of a stream of air produced by the HVAC unit,
said center of said spur gear being disposed radially between said flange and said second axis of said semi-circular pulley,
said base plate defining a slot extending arcuately between slot ends on said diameter and concentric with and spaced from said second axis,
said gear shaft extending through said slot for allowing said semi-circular pulley to rotate about said second axis as said slot moves along said gear shaft between said stop positions with said gear shaft engaging said slot ends at said stop positions,
said spur gear defining a cutout sector,
said attachment points disposed within said spur gear circumference and said cutout sector of said spur gear in each of said stop positions,
said circular pulley radius being equal to said spur gear radius,
said semi-circular pulley radius being four thirds greater than said circular pulley radius for rotating said semi-circular pulley two thirds of the rotation of said circular pulley, and
pulley gear teeth extending radially inwardly from said flange of said semi-circular pulley and engaging with said spur gear teeth of said spur gear for driving said spur gear and rotating said spur gear three halves of the rotation of said semi-circular pulley in response to the rotation of said circular pulley thereby creating a mechanical advantage and increasing the force generated by the rotation of said circular pulley and maintaining the rotation of said spur gear equal to the rotation of said circular pulley.
